(19) United States
(12) Patent Application Publication
(10) Pub. No.: US 2007/0061718 A1
(43) Pub. Date: Mar. 15, 2007

(54) Method for selecting character interpretation mode

(75) Inventor: Mikko A. Nurmi, Tampere (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/226,853

(22) Filed: Sep. 13, 2005

(51) Int. Cl. G06F 15/00

(52) U.S. Cl. 715/542

(57) ABSTRACT

This invention relates to a method for selecting an interpretation for a character sequence between different interpretation modes. In the solution a character input is received, at least part of the character input is analysed, an interpretation mode is selected based on the analysis, and an output character sequence is produced by modifying one or more characters in the input character sequence according to the selected input mode

### FIELD OF THE INVENTION

This invention relates to electronic typing. Particularly this invention relates to a method for selecting an interpretation for a character sequence between different interpretation modes.

### BACKGROUND OF THE INVENTION

Character input in electronic device can be carried out by a keyboard such as a general keyboard (e.g. QWERTY), where each letter has its own button, or a keyboard, where buttons have a combination of letters. For example, mobile terminals can have a keypad, which has eight buttons for letters, one for space and one for punctuation marks. The alphabets are divided to those eight buttons in such manner that each button comprises at least three letters and the number corresponding the button. The letters of each button can be browsed by pressing the button that many times the desired letter is presented. This kind of method is called multitap typing.

Currently predictive text input methods have become popular and fast way to input text in communication devices comprising keyboard/keypad. The advantage of the predictive text input, especially with keypads having “a contracted” keypad, is that the user can compose a word by pressing corresponding buttons once, whereby the predictive text input predicts a word composed of the letter/button combination in question. The letter combination is checked from a word database, wherefrom the corresponding word is retrieved. It can be seen that because each button has at least three letters, there can be several combinations which provide a real word. If the suggested word is not the right one, the user may choose some other word from the word database that comprises most commonly-used words composed of the letters of the pushed buttons.

The word database is generally limited by default to the most commonly-used words. Therefore when the user is typing text, which is not recognized by the predictive text input, the user normally has to type the word by the multitap typing mode. For changing the character interpretation mode, the user normally has to turn the predictive text input mode off and when the unrecognized word has been typed by the multitap typing mode, the character interpretation mode needs again to be changed to the predictive text input mode, if desired so. In some situations the user already knows in advance that a specific word will not be recognized. In this case also, the user has to change the typing mode to the multitap typing in order to input the correct word. It can be seen that even though the predictive text input mode quickens the text input, the typing may still lack usability when it comes to unrecognized words.

Publication US 2004/0177179 A1 discloses one method for improving usability for text input in a user terminal having a limited-size keyboard. In the method the predictive text input method and the multitap typing method are linked in such a way that toggling between the methods is enabled. The change of the method is performed as a result of text editing keystrokes of e.g. CLEAR or SPACE. Therefore this method is based on specific commands, according to which the change of the method is performed. Even though the solution improves the toggling between the two input methods, it also requires the user's attention for determining when the mode needs to be changed. It can be realized that this solution may be suitable for situations where the user already knows a word that is not recognized. However, for situations where the predictive text input is used by default and where the user does not want to observe the unrecognized words, the solution is not that suitable.

Therefore there is a need for a solution that would provide an improved method for text input by means of both predictive text input and multitap typing.

### SUMMARY OF THE INVENTION

The current invention aims to automatize the selection between different interpretation modes. The automatization means that the selection can be made without user's operations and ideally seamlessly to the user.

This aim is achieved by a method, an electronic device, a module and a computer program product for electronic character input.

The method comprises receiving a character input, analysing at least part of said character input, selecting an interpretation mode based on said analysis, and, producing an output character sequence by modifying one or more characters in the character input according to the selected input mode.

The electronic device comprises means for electronic character input, and is capable of receiving a character input, said device comprising an analysing unit for analysing at least part of said character input, said device comprising a mode selection unit for selecting an interpretation mode based on said analysis, said device being further capable of producing an output character sequence by modifying one or more characters in the character input according to the selected input mode.

The module is capable of receiving a character input, analysing at least part of said character input, selecting an interpretation mode based on said analysis, and producing an output character sequence by modifying one or more characters in the character input according to the selected input mode.

The computer program product for electronic typing comprises code means stored on a readable medium, adapted, when run on a computer, to receive a character input, to analyse at least part of said character input to select an interpretation mode based on said analysis, and to produce an output character sequence by modifying one or more characters in the character input according to the selected input mode.

By means of the invention, the user does not need to select the input mode by him/herself. The user decides, which typing mode he/she is going to use without a need for telling this selection to the device. After the decision the user types the word by the decided mode and the device interprets which mode is used and provides resulted word(s) according to the interpretation.

In many situations the current invention provides quicker text input, as the user does not constantly have to change between input modes. In the invention the input mode is automatically determined and/or updated.

The implementation of the current solution does not require rough changes to the text input application, only new program components are designed.

### DESCRIPTION OF THE DRAWINGS

An example of the invention is disclosed by means of the following description and the figures, wherein

FIG. 1 illustrates an simplified example of a use situation for the current solution,

FIG. 2 illustrates an example of a device wherein the current solution can be utilized, and

FIG. 3 illustrates an example of the method steps.

### DETAILED DESCRIPTION OF THE INVENTION

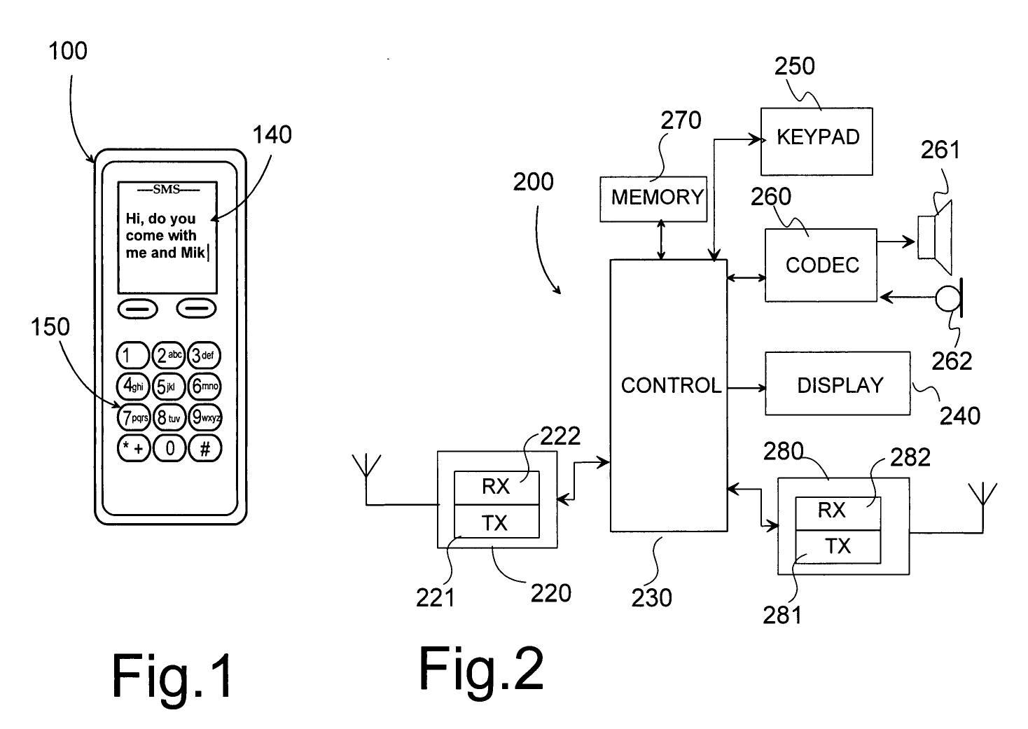

In the following description specific terms are used for the sake of clarity. These terms are intended to refer only to the particular structure of the invention selected for illustration in the drawings and are not intended to define or limit necessarily the scope of the invention. The invention relates to character input in electronic communication devices. Character input comprises either single sign, such as a letter or a number, or a sign sequence. Character inputting can be implemented in different ways and the solution now discussed is also usable among them. The solution is not targeted to any particular keyboard or text inputting system, but is aimed to facilitate the actual text input operation. In the description a general term “keyboard” is used, but it should be understood that the term refers to different text inputting systems such as e.g. a mobile keypad, a PDA virtual keypad, a stylus, a joystick, a rocker, a roll or some other selector for e.g. a list or a virtual keyboard, or any device capable of providing alphanumeric input in one form or another can benefit from the invention. Therefore the character input relates to pressing keys or selecting keys, wherein the keys belong to keypad or virtual keypad. The keyboard is purposed for example for writing short messages, multimedia messages, emails, calendar marks or any other text in the device. One example of the invention is illustrated in FIG. 1, where a user writes a short message by a device 100. The message is written by a keypad 150 and the composing message text is displayed on a display 140. For interpreting the characters being input, an interpretation mode is used. The interpretation can be a predictive text interpretation mode, when the user has input the characters by predictive text input mode. The interpretation can also be a multitap interpretation mode, when the user has input the characters by multitap typing. The interpretation mode can also be some other, by means of which a character combination is identified. As an example of other interpretation mode is a number interpretation mode, wherein by pressing a certain button and a number after that, a certain letter is obtained (e.g. “k” can be obtained by pressing “5” and “2”). The current invention therefore is targeted to a selection of different interpretation modes based on the characters the user has input. Therefore the current invention can foresee by means of the characters, which input mode the user intended to use.

The method according to the invention enables a selection between different character interpretation modes seamlessly to the user during the user is inputting characters. This means that the interpretation modes can be changed without user operation. Examples of the interpretation modes are predictive text interpretation and a multitap interpretation. However, the interpretation modes can be some other as well. The idea behind the invention is to determine whether the word being input is typed by the predictive text input and thus is aimed to be interpreted by the predictive text input mode or whether the multitap interpretation should be used. When the user begins to input a specific word, a determination for the interpretation between the predictive text and multitap is began. If the user generally utilizes predictive text typing, it may be assumed that the predictive text interpretation is also utilized for the current input. Similar assumption may be done, if multitap is used by default. The user may also provide a default mode by him/herself, if desired. However, depending on the mode that is already in use, the first assumption of the interpretation for the character combination can be done, and if it is wrong in relation to the one being used, the interpretation mode is changed. But it is clear, that the character combination can be interpreted at the time the characters are input, without a need for making any assumptions.

The first assumption of the typing mode can be given after a few characters. The number of characters may be a predefined number or a user definable parameter. In some languages a first character may be used for the assumption, if the character in question cannot be located at the beginning of any word in the language in question. When the word is completed by the user, the word is displayed to the user in such a form, which is provided by the determined interpretation mode.

If the determination indicates that the predictive text interpretation was used, then a suitable output character sequence, such as a word or words relating to the character combination in the word database are displayed to the user. However, if the character combination is not recognized by the predictive text interpretation, the word can be displayed as it was written by the multitap input. However, if the character combination results in “a word” that is not suitable result for either of the interpretation modes, the mode may be queried from the user. Due to this automatic determination, the user does not need to select the interpretation mode between words or in the middle of the word manually, but the user can begin inputting by either of the modes, whereby the solution according to the invention interprets which one is used. Therefore it can be seen that the user does not need to browse between different typing modes, but only to point out by writing which mode is wanted to be used for interpretation.

The determination for the interpretation mode in question can be done e.g. by determining the predictive text interpretation based on the amount of sequential same keystrokes. For example when the user types a word “Mikko”, which is a common Finnish name for men, with the predictive text input, the key selections are “MNO”, “GHI”, “JKL”, “JKL”, “MNO”. It can be seen that the same keys are pressed twice only with the character “K”.

However, if the user is inputting the word with multitap typing, the key selections are “MNO”, “GHI”, “GHI”, “GHI”, “JKL”, “JKL”, “JKL”, “JKL”, “MNO”, “MNO”, “MNO”. It can be seen here that same keys are pressed even three times for one character. If the same characters or if characters that are placed on a same button appear in the word sequentially, the amount of keystrokes will even increase. For example, the word “mono” would have nine keystrokes for the same key button “MNO”, “MNO”, “MNO”, “MNO”, “MNO”, “MNO”, “MNO”, “MNO”, “MNO”. If the multitap typing is used when the predictive text interpretation mode is on, the example words would not be recognized. The words corresponding to the combinations of the previous keystrokes cannot be found from the word database.

The determination for the interpretation modes can be implemented according to following criteria:

Predictive Text Interpretation Used for Interpretation

When the user has pressed each button mainly once while writing the word, it can be assumed that the user's purpose is to use predictive text input, and the interpretation is carried out by the predictive text interpretation. It can be realized from the previous examples that a certain percent of keystrokes for the word are done by other button that the previous button has been. In the predictive text input, a keystroke corresponds to a character, whereby sequential keystrokes will appear when two same characters or two characters from the same button are input.

In addition, when the keystrokes that are first interpreted as multitap typing provide a word that conflicts with the grammar of the specific language, predictive text input mode can be assumed to be used. For example, certain language can have only certain characters one after the other, and certain language does not have certain characters at all. If the multitap typing provides a word with a strange character combination, then the word can be assumed to be typed by predictive text input mode.

Multitap Interpretation

It is possible to assume the multitap typing mode to be used by opposed criteria than the predictive text input:
a) a certain number or percentage of the keystrokes are strokes of same keys sequentially,
b) the word is not found from the word database, or
c) the typed word is correct grammatically.

In addition, in the multitap typing the user has to wait awhile between two same keystrokes. In the example of “Mikko”, the two “k”'s should be written by “JKL” “JKL” “gap” “JKL” “JKL”, because “JKL”“JKL” “JKL”“JKL” would result in “5” in the display. If the gaps are detected between keystrokes, the word can be assumed to be written by the multitap typing.

In one implementation of the current example, when the user inputs the character combination by the multitap typing, and if the resulting word is found also from the word database that is used by the predictive text interpretation, the resulting word can be highlighted by a different color. Due to this, the user is given a possibility to expand his/her knowledge of the content of the database, and thus to use predictive text input mode in future for the same word. Because of this, the user may better estimate, which mode should be used for which word.

Implementation

The above mentioned examples are not the only criteria by means of which it is possible to determine the typing mode in question. Other criteria may relate to grammar or word structure. It should be noticed that one criterium may not always be enough for a good result. Therefore few criteria for the determination can be used. Because of that, it is understood that different criteria for determination are not the key points of this invention. What should be understood is the feature for providing a solution where the user does not need to browse between different interpretation modes, but only to point out by inputting, which interpretation is wanted to be used for the character combination.

Sometimes, the interpretation of the word may not be perfect. If the determination between predictive text interpretation and multitap interpretation is wrong, the user may be given an opportunity to select the mode by him/herself. Similarly, if the user has misspelled the word, the interpretation mode can be changed. It is therefore possible to change the interpretation during one word several times. In the case of misspelled words, which the user begins to correct, the input characters can be re-interpreted and the mode can be determined according to them. Therefore, the solution will maintain the existing modes, but bring more possibilities and automatization to it. However, it is understood that by defining specific rules, the interpretation may become very accurate and misinterpretations can be reduced.

The solution according to the invention can be implemented in an electronic device as a software program. An example of an electronic device is a mobile device as illustrated as block chart in FIG. 2, but also a PDA-device, computer, DVD-player, portable music players, TV etc. are possible. The device comprises communication means 220 having a transmitter 221 and a receiver 222 or is connected to such. There can also be other communicating means 280 having a transmitter 281 and a receiver 282 as well. The first communicating means 220 can be adapted for telecommunication and the other communicating means 280 can be a kind of short-range communicating means, such as a Bluetooth™ system, a WLAN system (Wireless Local Area Network) or other system which suits local use and for communicating with another device. The device 200 according to the example in FIG. 2 also comprises a display 240 for displaying visual information. Further the device 200 may comprise an interaction means, such as a keypad 250 for inputting data etc. In addition or instead of the keypad 250, the device can comprise stylus, whether the display is a touch-screen display. The device 200 comprises audio means 260, such as an earphone 261 and a microphone 262 and optionally a codec for coding (and decoding, if needed) the audio information. A control unit 230 may be incorporated to the device 200 for controlling functions and running applications in the device 200. The control unit 230 may comprise one or more processors (CPU, DSP). Further the device comprises memory 270 for storing e.g. data, applications, and computer program code.

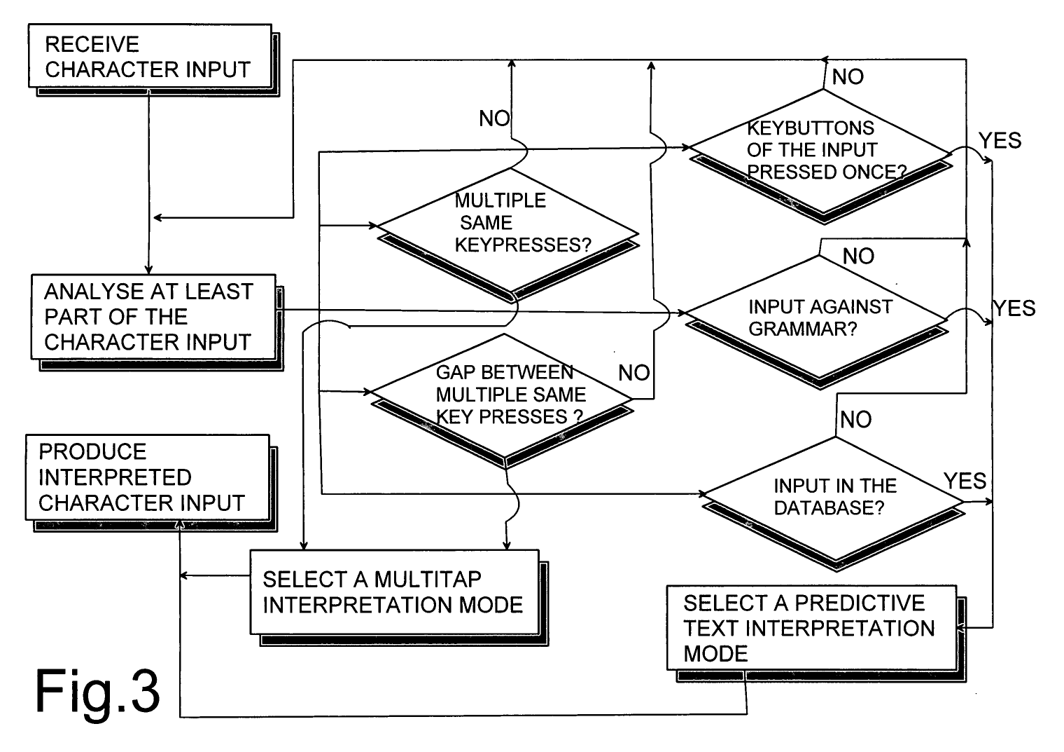

An example of method steps for the current invention are illustrated by a flowchart presented in FIG. 3. The character input is received and at least part of it is analysed. It is possible to base the analysing on a desired interpretation mode, but is also possible not to have any assumptions of the mode. The first assumption may be based on a habit, how the user uses the device normally, or on a previous mode that was used.

For analysing the character input, it is determined whether multiple same keypresses occur in the character input; whether there is a gap between multiple same keypresses; whether the keybuttons are pressed once; whether the character input is against grammar; or whether the character input is found from the database. The analysis may include analysing one or more of the previous conditions, and also conditions that are not mentioned here as an example. The conditions can be studied one at the time or in a group of few condition, or every condition at the same time. If a learning system is used, then the device is capable of learning which and/or how many combinations of conditions will result in the best result. It is also possible to give the user a possibility to define the combinations and/or amount of the conditions

The analysis can be started right after one character is being input or after few or all characters are input.

The interpretation mode can be selected right after the first analysis is done or after a few analyses. It should be noticed, that the interpretation mode can be changed during character input or during analysis. Similarly, the character input that has been interpreted and modified, can be reused as an input to be interpreted again. The first interpreted mode can be wrong, whereby the next interpretation may become better, if the modified characters from the previous interpretation round are taken into account. The modifying, which can be done during the character input or when all the characters are input, discussed here relates for actions such as replacing, adding, deleting, selecting, doing nothing, composing multiple characters of one characters, composing one character of multiple character.

The analysis unit and the mode selection unit can be two software components, or they can be arranged into one software component having means for their functions.

The previous description discloses a method for character inputting for electronic devices, wherein the interpretation mode can be changed while a user is writing e.g. a message. The examples presented are provided for understanding purposes and there it will be clear that variations and modifications of those are possible without departing from the scope of protection of the invention as set forth in the claims.

What is claimed is:

1. A method for electronic character input, comprising:
receiving a character input
analysing at least part of said character input
selecting an interpretation mode based on said analysis, and
producing an output character sequence by modifying one or more characters in the character input according to the selected input mode.

2. The method according to claim 1, wherein the character input comprises a single character and said method is carried out character by character.

3. The method according to claim 1, wherein the character input comprises a character sequence and said method is carried out sequence by sequence.

4. The method according to claim 1, wherein the modified one or more characters is used as part of the character input.

5. The method according to claim 1, wherein modifying relates to operations such as replacing, adding, deleting, selecting, doing nothing, composing multiple characters of one character, composing one character of multiple characters.

6. The method according to claim 1, wherein the interpretation mode is selected from a following group: predictive interpretation mode, multitap interpretation mode, number interpretation mode.

7. The method according to claim 1, wherein at least part of said character input is analysed during reception of said character input.

8. The method according to claim 1, wherein the output character sequence is displayed on a display.

9. The method according to claim 6, wherein predictive text interpretation mode is selected when keys composing the character input are mainly selected once.

10. The method according to claim 6, wherein predictive text interpretation mode is selected, when the character input appears to be against grammar.

11. The method according to claim 6, wherein multitap interpretation mode is selected, when the character input does not correspond to any word in a word database.

12. The method according to claim 6, wherein multitap interpretation mode is selected, when the character input comprises multiple same key selections.

13. The method according to claim 6, wherein multitap interpretation mode is selected, when a gap is detected between same key selections.

14. An electronic device comprising means for electronic character input, said device
being capable of receiving a character input,
comprises an analysing unit for analysing at least part of said character input
comprises a mode selection unit for selecting an interpretation mode based on said analysis,
being further capable of producing an output character sequence by modifying one or more characters in the character input according to the selected input mode.

15. The electronic device according to claim 14, wherein the analysing unit and the mode selection unit are one unit capable of both operations.

16. The electronic device according to claim 14, further comprising means for selecting characters to be input.

17. The electronic device according to claim 14 further comprising a display for displaying the output character sequence.

18. The electronic device according to claim 14, further comprising means for predicting text input.

19. The electronic device according to claim 14, being capable of detecting that keys composing the character input are mainly selected once and selecting a predictive text interpretation mode.

20. The electronic device according to claim 14, being capable of detecting that the character input appears to be against grammar and selecting a predictive text interpretation mode.

21. The electronic device according to claim 14, being capable of detecting that the character input does not correspond to any word in a word database and selecting a multitap interpretation mode.

22. The electronic device according to claim 14, being capable of detecting that the character input comprises multiple same key selections and selecting a multitap interpretation mode.

23. The electronic device according to claim 14, being capable of detecting that a gap is detected between same key selections and selecting a multitap interpretation mode.

24. The electronic device according to claim 14, comprising a keypad.

25. The electronic device according to claim 14, comprising a virtual keypad.

26. The electronic device according to claim 14, further comprising means for communication.

27. A module for electronic typing having:
means for receiving a character input,
means for analysing at least part of said character input,
means for selecting an interpretation mode based on said analysis, and
means for producing an output character sequence by modifying one or more characters in the character input according to the selected input mode.

28. The module according to claim 27, further having means for selecting the interpretation mode from a following group: predictive interpretation mode, multitap interpretation mode, number interpretation mode.

29. A computer program product for electronic typing comprising code means stored on a readable medium, adapted, when run on a computer,
to receive a character input
to analyse at least part of said character input
to select an interpretation mode based on said analysis, and
to produce an output character sequence by modifying one or more characters in the character input according to the selected input mode.

30. The computer program product according to claim 29, wherein the code means are further adapted to select the interpretation mode from a following group: predictive interpretation mode, multitap interpretation mode, number interpretation mode.

31. The computer program product according to claim 29, wherein the character input comprises a single character and the analysis is carried out character by character.

32. The computer program product according to claim 29, wherein the character input comprises a character sequence and said analysis is carried out sequence by sequence.

33. The computer program product according to claim 29, wherein the modified one or more characters is used as part of the character input.

34. The computer program product according to claim 29, wherein modifying relates to operations such as replacing, adding, deleting, selecting, doing nothing, composing multiple characters of one character, composing one character of multiple characters.
